(19) United States
(12) Patent Application Publication
(10) Pub. No.: US 2025/0336267 A1
(43) Pub. Date: Oct. 30, 2025

(54) VERIFIED GAME STREAMING

(71) Applicant: Microsoft Technology Licensing, LLC, Redmond, WA (US)

(72) Inventors: Nathalia Marie SCRIMSHAW, Bellevue, WA (US); Adam Michael SMITH, Sammamish, WA (US); Ethan Mark ABELES, Seattle, WA (US); Brian David WENTZ BURKE, Granada (ES)

(21) Appl. No.: 18/650,260

(22) Filed: Apr. 30, 2024

(51) Int. Cl. G07F 17/32

(52) U.S. Cl. CPC G07F 17/3227; G07F 17/3241

(57) ABSTRACT

At a proxy outside a virtual machine which is hosting a game in a cloud, some embodiments select a network communication which represents a call from the game or the virtual machine. The proxy modifies a header of the call, or adds a new header, with a security token which is distinct from any user authentication token of a game player. A call receiver extracts the token and uses it in an attempt to discern an identity, such as a streaming provider identity. The call receiver performs a management action, and responds to the call, based on one or more of: the streaming provider identity or another result of the attempt, the particular call, or the presence of the security token. The management action manages a game streaming support item such as a licensing mechanism, an analytics mechanism, a game configuration, or a telemetry service.

### BACKGROUND

Some video games are played through the Internet or another computer network. Online games date back to early packet-based computer networking in the 1970s, and are widely present today on gaming platforms that include personal computers, gaming consoles, and various kinds of mobile devices. As the World Wide Web developed and browsers became more powerful, games emerged that use a web browser as a client. Games can be categorized, e.g., as first-person shooters, strategy games, and massively multiplayer online role-playing games. Some online games are provided through a games-as-a-service infrastructure. Games range from simple text-based environments to environments with complex graphics in virtual worlds. The online portion of a game can be a minor feature such as a leaderboard, or a central part of gameplay such as real time interactive play against other players.

Although many advancements have been made, there is still room for improvement in online game technology.

### SUMMARY

Some embodiments address technical challenges arising in streaming games. One challenge is how to port a game which is designed to run on a standalone workstation from that standalone environment into an online streaming environment when the game's source code is unavailable. Another challenge is how to port a game which runs each time on the same machine to an online streaming environment in which the game often runs on different machines from one execution to the next. Another challenge is how to secure a game against unauthorized play in an online streaming environment when a game's licensor and the game's streaming provider are different entities. Other technical challenges are also addressed herein.

Some embodiments taught herein provide or utilize verified game streaming technology which receives a request via a network communication, the request being part of a call to a service, the call associated with a virtual device, the call also associated with a game installed on the virtual device; extracts a security token from the request; attempts to discern a verified game streaming provider identity based on at least the security token; and takes action based on at least a result of the attempting. Actions taken vary, but some embodiments perform at least one of: an identity operation with an identity of the virtual device; an analytics operation with the virtual device or the game or both; a game configuration operation with the game; or a refusal operation after failing to discern the game streaming provider identity or ascertaining that the game streaming provider identity identifies an unauthorized entity.

Other technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use as-is game streaming (AIGS) functionality;

FIG. 2 is a block diagram illustrating dataflow and other aspects of a family of enhanced systems which are each configured with AIGS functionality;

FIG. 3 is a block diagram illustrating aspects of another family of systems which are each enhanced with AIGS functionality, including some systems with software which upon execution performs a first family of AIGS methods;

FIG. 4 is an architecture dataflow diagram illustrating aspects of AIGS functionality in an architecture for game streaming;

FIG. 5 is a block diagram illustrating aspects of game streaming operations in an architecture with AIGS functionality;

FIG. 6 is a flowchart illustrating a second family of AIGS methods; and

FIG. 7 is a flowchart further illustrating AIGS methods, and incorporating as options the steps of FIGS. 2, 3, 4, and 6.

### DETAILED DESCRIPTION

### Overview

Some teachings described herein were motivated by technical challenges faced and insights gained during efforts to improve technology for game streaming, particularly but not exclusively for scenarios in which a legacy game designed to be installed and then run on a single machine is being ported into a cloud environment where it will run in one or more virtual machines. These challenges and insights provided some motivations, but the teachings herein are not limited in their scope or applicability to these particular tools, motivational challenges, solutions, or insights.

Efforts to port video games from a workstation or laptop environment to a streaming environment sometimes encounter challenges, because different assumptions apply in the different environments. Many games that were designed for a single-machine environment such as a workstation or a laptop rely on assumptions that (a) the game will be installed once on that machine, and (b) the game will then run repeatedly on that same machine. These assumptions are embedded in licensing mechanisms to prevent unauthorized gameplay, e.g., via unauthorized copies of the game.

However, these assumptions are not correct in a cloud streaming environment, where the game will be installed in different virtual machines that sometimes run on different underlying hardware. There is no guarantee that the game will run on the same underlying hardware, or even on the same virtual machine, from one execution of the game to the next, even for the same authorized user of the game.

In particular, device-limited licensing can be problematic for legacy games and other legacy applications when those legacy applications will run in a cloud. As an example, assume a licensing mechanism is configured to enforce a license that allows running an application on up to five devices. If this licensing mechanism and five-device license are used when running the application on a cloud instance, one of those five allowed device licenses is exhausted each time the application restarts on a different device in the cloud. Moreover, in a device-licensing system, allowing multiple unrelated users to share the same device via a cloud system is also problematic as it can allow hundreds of users to share the same copy of a game without purchasing it.

Some embodiments taught herein provide a way to allow trusted third-party cloud providers to indicate that an instance of an application is running in their cloud, without exposing the corresponding authentication secrets (tokens, etc.) to the application. Thus, users will only see a single cloud device license, rather than constantly exhausting their device licenses as the cloud instance changes. In addition to keeping the secrets separate from the security domain in which the application is running, some embodiments avoid reliance on modifications to the application. In some scenarios, modifications to applications are not feasible, e.g., because the application's source code is lost or unavailable, or the application's developer does not agree to changes or cannot be located. Instead of relying on application modifications, some embodiments instead modify a few services and thereby make a large set of applications usable for streaming from a cloud.

Some embodiments described herein utilize or provide a game streaming method performed in a computing network, the method including automatically: receiving a request via a network communication, the request part of a call to a service, the call associated with a virtual device, the call also associated with a game installed on the virtual device; extracting a security token from the request; attempting to discern a verified game streaming provider identity based on at least the security token; and based on at least a result of the attempting, performing an operation.

This as-is game streaming (AIGS) functionality has the technical benefit of helping to secure the game against unauthorized play without exposing the security token to the game, or to the virtual device, which reduces the attack surface. This AIGS functionality also has the technical benefit of helping to secure the game against unauthorized play without requiring any change to the game itself, which increases the corpus of games that can be secured in this manner and also lowers the computational costs and personnel costs of securing the games.

Although many of the examples herein refer to “as-is” game streaming or AIGS, such references are merely intended to emphasize the applicability of teachings herein to legacy games, also known as retro games, not as a limitation to such games only. The difficulty or practical impossibility of modifying games—and hence the benefits of embodiments free of reliance on such modifications—is especially clear for older games whose source code or original developers or both are not presently available. But whether a game is considered a legacy game or not, or considered a retro game or not, by any one or more entities, has no bearing on the scope of the claims or the applicability of this disclosure's teachings.

Some embodiments perform an identity operation which includes at least one of: registering an identity of a pseudo-device in a device directory in place of the identity of the virtual device; registering an identity of a device group in a device directory in place of the identity of the virtual device, the device group containing multiple virtual devices; bypassing registration of the virtual device in a device directory; bypassing entry of the virtual device into a list of devices owned by a user; or bypassing incrementation of a user's device count in response to use of the virtual device by the user.

This AIGS functionality has the technical benefit of preventing mistaken or misleading messages to a user over time as the game runs on different virtual devices in the cloud, while maintaining compatibility with an existing device-limited licensing framework. Although the user is benefitting from running the game on different virtual devices, those virtual devices are not treated as distinct individual devices by the licensing framework, unlike a scenario in which the user installs and runs the game on five standalone physical (as opposed to virtual) devices, e.g., five different laptop machines. Non-virtual machines continue to count against a maximum-allowed-devices limit, but additional virtual machines beyond the first virtual machine are not counted against that limit.

Some embodiments perform an analytics operation which includes altering a quality-of-service threshold to correspond with a streaming latency instead of a home play latency. This AIGS functionality has the technical benefit of reducing or avoiding mistaken activities that would be undertaken in response to quality-of-service determinations. Streaming latency is typically greater than home play latency. Gameplay metrics or gameplay mechanism adjustments will thus be based on accurate data instead of reflecting now-inaccurate assumptions built into games that were designed for a standalone environment, thereby enhancing telemetry accuracy and game enjoyment.

Some embodiments perform a game configuration operation which includes determining a game setting which is tailored for use when a game is running in a game streaming environment. This AIGS functionality has the technical benefit of providing game functionality which is unavailable for gameplay on a given standalone device. Some streaming environments support enhancements such as more detailed graphics, more computationally intensive play, or other aspects of games that are more constrained—or not available at all—on a particular standalone device. These enhancements are accomplished by providing the virtual device with greater processing power, more memory, or both, than the standalone device, and setting the game's settings to match the virtual device rather than matching a less capable physical device that is being used as a thin client or used primarily only for I/O.

These and other benefits will be apparent to one of skill from the teachings provided herein.

### Operating Environments

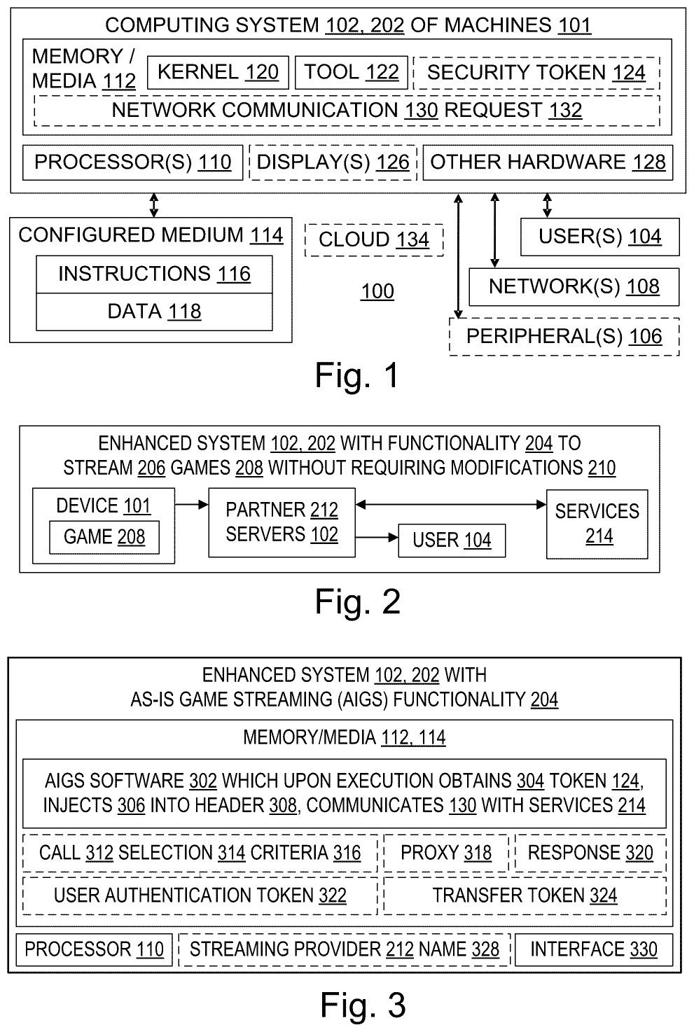

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other non-empty group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Although for convenience, examples and claims herein sometimes speak in terms of accounts, “account” means “account or session or both” unless stated otherwise. In this disclosure, including in the claims and elsewhere, a statement about activity by “the user account or the user session” for example does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or non-empty set 428 of accounts, user or non-empty group of users, IP address or non-empty group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user 1/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, AIGS functionality 204 could be installed on an air gapped network 108 and then be updated periodically or on occasion using removable media 114, or not be updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the AIGS functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein.

FIG. 3 shows some aspects of some enhanced systems 202. Like FIG. 2, FIG. 3 is not a comprehensive summary of all aspects of enhanced systems 202 or all aspects of AIGS functionality 204. Nor is either figure a comprehensive summary of all aspects of an environment 100 or system 202 or other context of an enhanced system 202, or a comprehensive summary of any aspect of functionality 204 for potential use in or with a system 102. FIG. 3 items are discussed at various points herein.

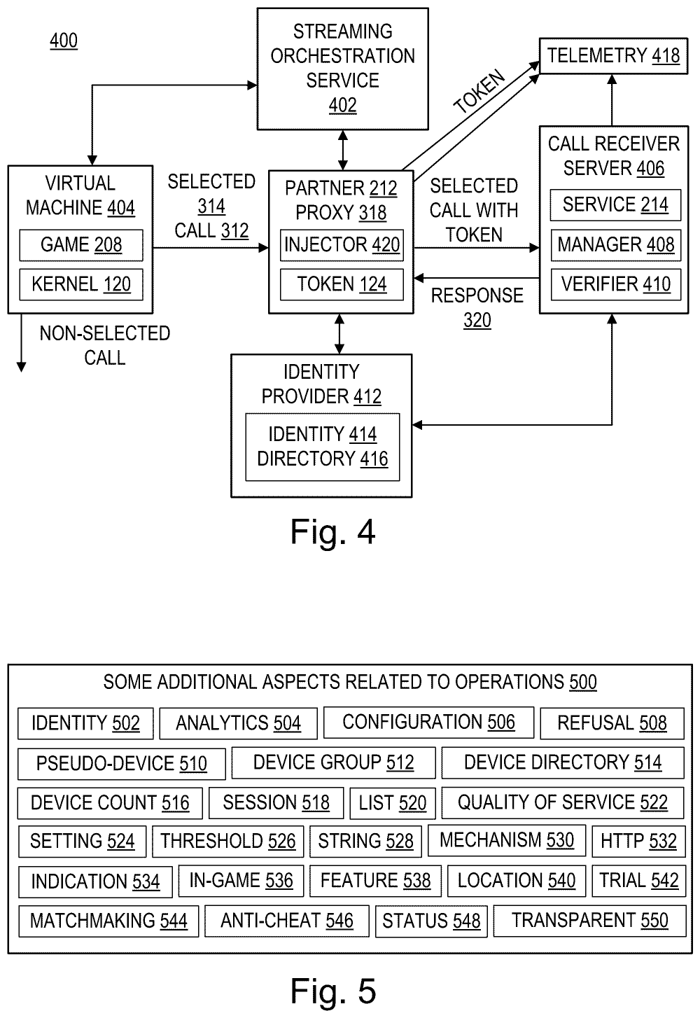

FIG. 4 is an architecture dataflow diagram illustrating aspects of AIGS functionality in an architecture 400 for game streaming. FIG. 4 is an example, and other architectures also embody teachings presented herein, are within the scope of claims presented, or include AIGS functionality 204, even though they differ from FIG. 4.

FIG. 5 shows some additional aspects related to operations 500 which form part of functionality 204 or interact with functionality 204. This is not a comprehensive summary of all aspects of functionality 204. FIG. 5 items are discussed at various points herein.

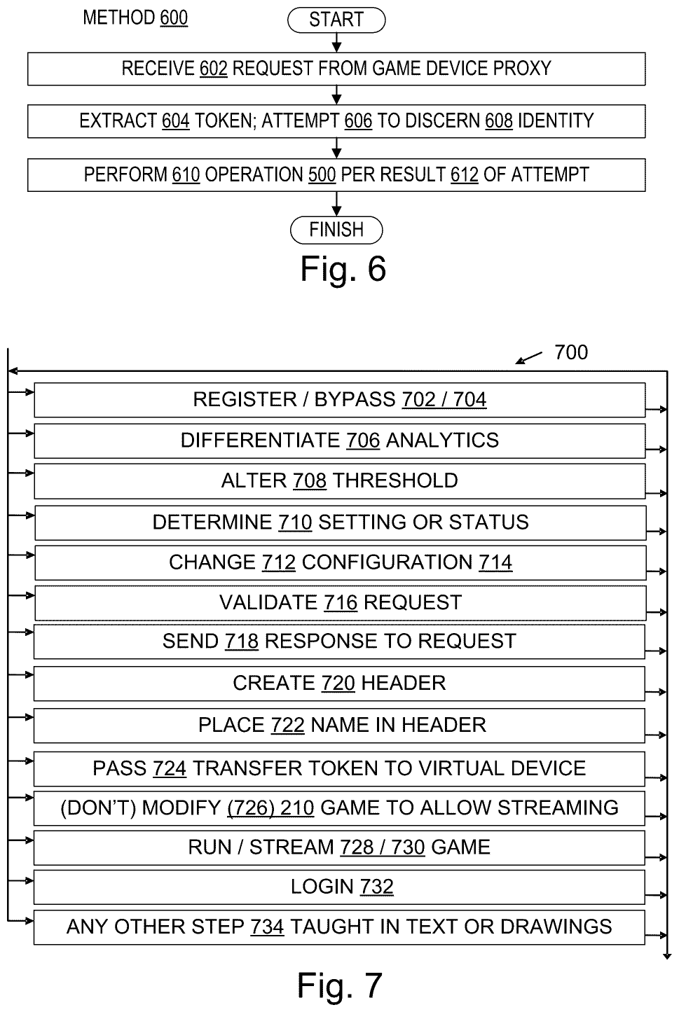

The other figures are also relevant to systems 202. FIGS. 6 and 7 are flowcharts which illustrate some methods of AIGS functionality 204 operation in some systems 202.

In some embodiments, the enhanced system 202 is networked through an interface 330. In some, an interface 330 includes hardware such as network interface cards, software such as network stacks, APIs, or sockets, combination items such as network connections, or a combination thereof.

Some embodiments include a computing system 202 which is configured to utilize or provide AIGS functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101. Similarly, the phrase “processor set” is used to emphasize that a processor 110 is not necessarily confined to a single chip or a single machine 101. Sets are non-empty unless described otherwise.

Depending on the embodiment, zero or more of the following items reside in the at least one digital memory 112 which is within the scope of the system 202. In other cases, items created, read, transferred, updated, or otherwise used by method embodiments are not necessarily within the system 202 per se but reside in the ambient environment 100. Some examples of memory-resident items include games 208, AIGS software 302, tokens 124, 322, 324, headers 308, names 328, responses 320, device counts 516, lists 520, settings 524, thresholds 526, strings 528, proxy 318 software, kernels 120, call receiver server software 406, streaming orchestration service software 402, identities 414, refusals 508, and results 612.

In embodiments, the system 202 includes at least one processor 110 in operable communication with the at least one digital memory. The at least one processor 110 is configured to perform an AIGS method 700, also referred to as a verified streaming method 700. This method 700 includes any sequence of steps taught herein to utilize or provide functionality 204.

FIG. 4 shows an architecture diagram. In FIG. 4, a game 208 is running 728 on a virtual machine 404. The virtual machine also runs an operating system 120 and runs some cloud streaming software, e.g., storefront software. In operation, a call is made to support execution of the game. A proxy layer outside the virtual machine determines whether the call is a selected receiver call or a non-selected call such as a non-receiver call. This enhances security, by helping to ensure that no matter how compromised the VM itself may be, code inside the VM lacks access to the identity provider, and is unable to influence the proxy's logic. Non-receiver calls are calls that do not involve the receiver, and they proceed according to behavior that is not of interest here.

In some embodiments, the tokens are sometimes added (or not added) based on more granularity than simply request receiver. That is, not all (or even most) calls to a given call receiver server 406 are subject to injection 306. Rather, only calls to select call receiver routes or destinations are subject to selection 314.

Although it is shown as separate in FIG. 4, in a given implementation the partner proxy could run on the virtual machine, or the partner proxy and the virtual machine could run on the same physical hardware, or both. However, a benefit of running the proxy outside of the VM itself is enhanced security. If the VM is compromised by a bad actor, they could not immediately or easily gain access to the token outside the VM, nor can they understand what calls are being modified since the selection 314 is outside of the scope of the VM.

In the FIG. 4 example, the partner proxy runs injector software 420. The injector communicates with an identity provider 412 to obtain 304 a token (e.g., a bearer token), injects 306 the token into a new header of the call, and forwards the call with the injected token to a receiver server 406. A verifier 410 on the receiver server uses the injected token to verify that the call is authentic and to identify the partner. Then a manager 408 on the receiver server initiates or performs at least one management action, e.g., bypassing 704 registration of the virtual machine as a user device and registering 702 a cloud device 510 instead. Examples of supported management actions include identity actions 502, analytics actions 504, configuration actions 506, and refusal actions 508. Finally, the manager 408 sends a response 320 back to the injector indicating how the receiver call was handled.

In some embodiments, the response 320 includes a call 312 response that is directly forwarded back to the VM. Some embodiments also support an additional set of responses 320 that augment the underlying call's protocol to indicate to the proxy whether the additional management action(s) were taken, given the presence of the token, and management action results. This allows the proxy to distinguish between (a) the underlying request's success/failure/status and (b) the additional management action(s) success/failure/status.

In FIG. 4, a Streaming Orchestration Service 402 interacts with the Partner 212 Proxy 318, to help ensure that a proxy is ready and available for the virtual machine. Service 402 is also responsible for the initialization of the virtual machine 404. In one view, virtual machine 404 operates as a streaming server.

In some embodiments, the verified game streaming functionality 204 includes three aspects, which are noted below and discussed at various points in the present disclosure.

One aspect is creation of a secure token 124 that identifies the specific game streaming partner, e.g., a token that no other entity could produce. Some embodiments leverage Azure® Active Directory (AAD) or another directory 416 of an identity provider 412 and its Server-to-Server Authentication or similar authentication methods to produce a secure token, which only the owner of the AAD application or similar application can generate (mark of Microsoft Corporation). In some cases, this follows an OAuth flow for token creation, such as a flow of an OAuth 2.0 framework, which is an open standard published by the Internet Engineering Task Force in 2012.

A second aspect of functionality 204 in some embodiments is a proxy service that sits outside of the game streaming host OS 120. This proxy 318 receives traffic from all virtual machines (VMs) 404 whose behavior is to be modified. Some embodiments only send a specific set of calls through the proxy, in order to optimize efficiency and reduce the risk of unintentionally breaking other calls made by either the host OS or the game. The proxy service looks for and identifies the calls 312 to be modified, and injects 306 the secure token generated previously as part of a header 308 into the HTTPS call and forwards it to the receiving service 214, 406. This appends functionality 204 data to call data that is being transmitted from the virtual machine to the receiving service.

In a third aspect of functionality 204, the receiving services are modified to look at the headers of calls to detect the injected 306 token. When one of these new or modified headers is detected, the service verifies the authenticity of the sender via token verification to ensure it comes from an authorized application, e.g., an application on an allow list, or an application not on a deny list. Then the call receiver takes action to implement the adapted or added functionality for licensing, telemetry, in-game purchases, etc. The action taken is based in some scenarios on which caller the call was received from, as well as being based on verification that it was from a valid partner.

In some embodiments, OAuth is used to generate the secure token material and provide a verifiable and secure way to identify a specific game streaming provider. In some embodiments, REST calls are intercepted outside of the virtual machine, the secure token is directly injected into those secure calls, and then the receiving processes can take action and perform different actions than it would for non-game streaming machines. In some embodiments, this is done without 726 any modification 210 to the virtualized OS or running game, while in others, modification or setup of the virtualized OS is performed, e.g., to support communications with the proxy as described below. This is beneficial, because many games were never designed to self-identify to their game services if they are running in the cloud (cloud streaming being a newer technology) and a developer might be unable or not want to update their game to do such self-identification.

In some embodiments, modification or setup of the virtualized OS is performed to support communications with the proxy. Due to the secure nature of HTTPS communications, intercepting and modifying requests via a proxy as described herein is sometimes interpreted as a security threat and to be blocked. This type of threat is often called a “Man in the Middle” attack. These embodiments, establish a certificate authority (CA) configured to sign SSL certificates in the proxy service, and ensure that this CA is installed in the virtualized OS as a trusted root certificate authority. The proxy returns SSL certificates signed by this CA during the HTTPS setup communications (a.k.a. TLS handshake) with the virtualized OS.

More generally, some embodiments use one or more of the following for calls 312, responses 320, or both: REST (Representational State Transfer), SOAP (Simple Objects Access Protocol), RPC (Remote Procedure Call), GraphQL, HTTP, or HTTPS traffic.

Tools and techniques taught herein allow the identification of cloud-based clients without modifications 210 to the OS or the platform that the game runs on, or modifications 210 to the game's own code. Functionality 204 instead intercepts and modifies service calls, and modifies and the services they're calling. This approach is much more scalable than a game-by-game approach. It also reduces or avoids burdens on game developers and storefront developers. Generally gaming services are not infrequently updated after the game launches, which provides a path for modification after a game's release.

Other system embodiments are also described herein, either directly or derivable as system versions of described processes or configured media, duly informed by the extensive discussion herein of computing hardware.

Although specific AIGS architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of AIGS functionality, for example, as well as different technical features, aspects, mechanisms, software, expressions, operational sequences, commands, data structures, programming environments, execution environments, environment or system characteristics, proxies, or other functionality consistent with teachings provided herein, and may otherwise depart from the particular examples provided.

### Processes (a.k.a. Methods)

Processes (which are also be referred to as “methods” in the legal sense of that word) are illustrated in various ways herein, both in text and in drawing figures. FIGS. 6 and 7 each illustrate a family of methods 600 and 700 respectively, which are performed or assisted by some enhanced systems, such as some systems 202 or another AIGS functionality enhanced system as taught herein. Method family 600 is a proper subset of method family 700. Moreover, activities identified in FIGS. 2, 3, and 4 include method steps, which are likewise incorporated into method (a.k.a. process) 700. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types or speaks an input such as a particular value for a name 328. Such input is captured in the system 202 as digital text, or captured as digital audio which is then converted to digital text. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 7. FIG. 7 is a supplemental portion of the textual and figure drawing examples of embodiments provided herein and the descriptions of embodiments provided herein. In the event of any alleged inconsistency, lack of clarity, or excessive breadth due to an interpretation of FIG. 7, the content of this disclosure shall prevail over that interpretation of FIG. 7.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 700 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 7 to be non-operable, the sequence S is not within the scope of any claim. Any assertion otherwise is contrary to the present disclosure.

Some embodiments provide or utilize a game streaming method 700 in a computing system 102, e.g., in a computer network 108. The method 700 includes automatically: receiving 602 a request 132 via a network communication 130, the request part of a call 312 to a service 214, the call associated with a virtual device 101, 404, the call also associated with a game 208 installed on the virtual device; extracting 604 a security token 124 from the request; attempting 606 to discern 608 a verified game streaming provider 212 identity 414 based on at least the security token; and based on at least a result 612 of the attempting, performing 610 at least one of: (a) an identity 502 operation 500 with an identity 502 of the virtual device; (b) an analytics 504 operation 500 with the virtual device or the game or both; (c) a game configuration 506 operation 500 with the game; or (d) a refusal 508 operation 500 after the attempting fails to discern the game streaming provider identity or ascertains that the game streaming provider identity identifies an unauthorized entity. A “game streaming provider” may also be referred to as a “third party cloud provider”, “cloud streaming partner”, or “Streaming Partner”. In some variations, the call 312 is associated with the virtual device 101, 404 but is not associated with any particular game. In some embodiments, an identity/device registration portion is part of a device-specific call, separate from a game-specific call.

In some embodiments, the method 700 includes performing the identity operation, and the identity operation includes at least one of: registering 702 an identity of a pseudo-device 510 in a device directory 514 in place of the identity of the virtual device (e.g., “cloud device” is a pseudo-device, in place of the VM identity); registering 702 an identity of a device group 512 in a device directory in place of the identity of the virtual device, the device group containing multiple virtual devices (e.g., “Tetris VMs” is a device group, and so is “Contoso VMs”); bypassing 704 registration of the virtual device in a device directory; bypassing 704 entry of the virtual device into a list 520 of devices owned by a user; or bypassing 704 incrementation of a user's device count 516 in response to use of the virtual device by the user (VM does not count against user's max allowed number of licensed devices).

In some embodiments, the method 700 includes performing the analytics operation, and the analytics operation includes at least one of: differentiating 706 analytics for how the game is running 728 in a game streaming 730 session 518; or altering 708 a quality-of-service 522 threshold 526 to correspond with a streaming latency instead of a home play latency.

In some embodiments, the method 700 includes performing the game configuration operation, and the game configuration operation includes at least one of: determining 710 a game setting 524 which is tailored for use when a game is running in a game streaming environment; determining 710 a game matchmaking 544 service setting 524; or determining 710 a game trial 542 configuration 506 or a status of a game trial 542 mechanism.

In some embodiments, the method 700 includes selecting 314 the call 312 for bearer token 124 insertion, and the selecting is based on at least one of the following criteria 316: a call identity 502 which distinguishes the call from at least one other call; a service identity 502 which distinguishes the service 214 from at least one other service; a service location 540; a game identity 502 which distinguishes the game 208 from at least one other game; or the game streaming provider 212 identity 414, 502, which distinguishes the game streaming provider from at least one other the game streaming provider. In some embodiments, the selecting 314 is performed in a proxy 318 which is outside the virtual device 404.

In some embodiments, the method 700 includes sending 718 a response 320 to the request via the computing network, and the response includes at least one of: the result 612 of the attempting; or an indication 534 of at least one operation 500 which was performed 610 based on at least the result of the attempting.

In some embodiments, the method 700 includes at least one of: changing 712 an in-game 536 purchase configuration 714 or an in-game purchase user interface 330 based on at least the game streaming provider identity; changing 712 an anti-cheat 546 configuration 714 or a status 548 of an anti-cheat mechanism based on at least a response 320 to the request; changing 712 an in-game 536 configuration 714 or a status 548 of an in-game feature 538 based on at least a response to the request.

Some embodiments provide or utilize a game streaming method 700 in a computing system 102, e.g., in a computer network 108. The method 700 includes automatically: receiving 602 a hypertext transfer protocol (HTTP) 532 request 132 via a network communication 130, the HTTP request part of a call 312 to a service 214, the call associated with a virtual device 101, 404, the call also associated with a game 208 installed on the virtual device; extracting 604 a bearer token 124 from a header 308 of the HTTP request; attempting 606 to discern 608 a verified game streaming provider 212 identity 414 based on at least the bearer token; and based on at least a result 612 of the attempting, performing 610 at least one of: (a) an identity 502 operation 500 with an identity 502 of the virtual device; (b) an analytics 504 operation 500 with the virtual device or the game or both; (c) a game configuration 506 operation 500 with the game; or (d) a refusal 508 operation 500 after the attempting fails to discern the game streaming provider identity or ascertains that the game streaming provider identity identifies an unauthorized entity. In some embodiments, the HTTP request is a secure HTTP request, namely, an HTTPS request.

In some embodiments, the method 700 includes validating 716 at least a portion of the HTTP request based on at least the bearer token.

An alternative approach to identifying a cloud streaming caller would presume that cloud streaming services are hosted services and their calls to licensing API's will come from known IP addresses. The caller IP address is available to services as a header at the ingress layer and in theory could be used to identify the caller. However, unlike the token-based approaches described herein, this IP address-based approach would impose a significant maintenance overhead to keep lists of IP ranges synchronized between cloud streaming service and call receiver services.

In some embodiments, the method 700 includes sending 718 a response to the HTTP request via the computing network after the attempting succeeds in discerning 608 the verified game streaming provider identity.

In some embodiments, one or more of the bearer token 124 itself, the extracting 604, and the attempting 606 are transparent 550 to the game which is installed on the virtual device. That is, the game has no direct access to whichever of the foregoing are transparent to the game.

In some embodiments, the method 700 includes injecting 306 the bearer token into the header of the HTTP request prior to the receiving 602, and the bearer token 124 is distinct from a user authentication token 322 of the HTTP request.

In some embodiments, the method 700 includes placing 722 a game streaming provider name 328 into the HTTP request prior to the receiving 602, the game streaming provider name including a string 528 which represents a name of the game streaming provider.

In some embodiments, the method 700 includes selecting 314 the HTTP request for bearer token insertion, wherein the selecting is based on at least one of: a call identity which distinguishes the call from at least one other call; a service identity which distinguishes the service from at least one other service; a service location; a game identity which distinguishes the game from at least one other game; or the game streaming provider identity, which distinguishes the game streaming provider from at least one other the game streaming provider.

In some embodiments, the method 700 includes passing 724 the virtual machine a transfer token 324 after a user login 732, wherein the transfer token permits the game to be launched and streamed without an additional login 732.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items such as AIGS software 302, tokens 124, 322, 324, headers 308, names 328, responses 320, device counts 516, lists 520, settings 524, thresholds 526, strings 528, proxy 318 software, kernels 120, call receiver server software 406, streaming orchestration service software 402, identities 414, refusals 508, and results 612, in the form of data 118 and instructions 116, read from a removable storage medium 114 and/or another source such as a network connection, to form a configured storage medium. The foregoing examples are not necessarily mutually exclusive of one another. The configured storage medium 112 is capable of causing a computer system 202 to perform technical process steps for providing or utilizing AIGS functionality 204 as disclosed herein. The Figures thus help illustrate configured storage media embodiments and process (a.k.a. method) embodiments, as well as system and process embodiments. In particular, any of the method steps illustrated in FIGS. 6 and 7, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a game streaming method 700 in a computer network or other computing system. This method 700 includes any of the methods disclosed herein.

### Additional Observations

Additional support for the discussion of AIGS functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. It is in the context of this understanding, which pertains to all parts of the present disclosure, that examples and observations are offered herein.

One approach to making games available includes cooperation between a game rights owner, e.g., licensor, and one or more game streaming partners. But in some scenarios the effort and changes associated with making a game ready for a new platform are high. In many cases, suitably situated developers are unavailable, or are not able to modify their games to support specific functionality that would permit or aid making the game and its associated gaming services run correctly from the cloud. The challenge becomes even greater when trying to bring an entire catalog of games, along with services 214 such as licensing, in-game purchase, and telemetry functionality, not only so they work correctly, but also so they operate in a manner that users can understand and provide alternative actions when a user is running their games from the cloud.

Some embodiments described herein provide or utilize reproducible techniques that effectively permit changes in how games within a gaming platform or storefront interact with supporting services, and provide that functionality enhancement without modifying either the game itself or the platform the game is running on. For instance, a storefront and the game content within it are effectively enabled to run content from a virtual personal computer in a cloud. Moreover, embodiments provide secure authentication and telemetry, with a high level of accountability and auditability.

### Game Streaming Partner Guidance, Injection Guidance

This portion of the present disclosure document provides an overview and technical guidance to game streaming partners on how they can integrate a storefront or other games repository onto their platform. Integration plans can change over time as improvements are made, calling for work from both the games owner and the partner streaming platform. After a storefront is successfully added to a streaming service, customers are able to stream a game with a valid entitlement. This entitlement can come from purchasing the game in the storefront, for example, to obtain a valid license for a user's active entitlement when they are signed in.

To help storefronts and other repositories determine when a game is being streamed via a partner streaming service for their own telemetry, some approaches set a Registry Key when a VM is provisioned and before a game is launched so that data streams can capture this data. Some include a correlation vector or other identifier that is different for each request, to facilitate debugging and investigation of the call.

Header Injection. To properly identify gaming virtual machines and change or trigger device registration, licensing, and sign in policies, the streaming platform injects 306 a bearer token into calls made to a set of services 214. For the service 214 provider to validate 716 that the calls are coming from a valid third-party game streaming provider, some embodiments utilize bearer tokens, e.g., AAD Bearer Tokens, to uniquely identify the cloud streaming provider and enable the special cloud streaming licensing or other management 408 behavior.

These calls 312 are often made at the OS level but some can be triggered by in-game APIs, e.g., where the OS or game is attempting to get a license for a piece of content or confirm a license or ownership for a piece of content.

Calls to are routed to a proxy. The game streaming provider proxy injects a header, which will allow for device-based licensing to work on cloud gaming VMs and prevent devices from being registered to the user's device list. Modifying mechanisms and control flow for device registrations for game streaming users improves user experience. Without the functionality 204 enhancement, each time a user launches a game on a virtual machine, a device registration would occur and populate in the user's device list. This would quickly clog up the number of devices and would need to be manually deleted. Continued additions/removals may also trigger fraud policies in device registration services. Moreover, some games rely on the device for a license rather than the user. When a user has more than 10 devices registered to their account, device-based licensing fails.

One embodiment injects a request header along the lines of Contoso-GameStreaming-Authorization: Bearer eyJ0 . . . <truncated>. The corresponding response includes a “Contoso-GameStreaming-Authorization-Ack” with support for variations such as the following as different responses.

Case 1. The “ . . . -Ack” header in the response contains “Ok” which means the Bearer token is valid and accepted. The request is handled specially and DeviceId is NOT registered.

Case 2. The “ . . . -Ack” header in the response contains “Expired” which means the Bearer token is recognized as belonging to the Streaming Partner but expired and should be refreshed. The request is NOT handled specially and DeviceId is NOT registered. Requests will fail, will not get to device registration.

Case 3. The “ . . . -Ack” header in the response contains “Invalid” which means the Bearer token is NOT recognized as belonging to the Streaming Partner. The request is NOT handled specially and DeviceId is NOT registered.

Case 4. The “ . . . -Ack” header is absent in response which means the receiver 406 backend doesn't recognize the usage of “Contoso-GameStreaming-Authorization” header at all and DeviceId is NOT registered. In this case, the streaming provider should not allow a game to be launched, to prevent additional registrations from occurring downstream such that gamers exhaust their device limits.

The -Ack header will be sent in the cases 1-3 as described. Case 1 will result in an http 200 response with a valid license and the game being able to launch. Cases 2-3 will result in an http 401 status code which the VM client will treat as an authorization or authentication failure and the device id will not be registered. The game will not get a license in this case and cannot be launched.

Additionally, some embodiments inject a header in requests to help identify the Game Streaming partner for telemetry 418 purposes. A “From” header is added, with the value being a constant string value that identifies the Game Streaming partner, eg “PartnerX” or “PartnerY”. The string value can be anything the partner chooses, however by convention I would be something that can be easily understood to refer to the particular partner. Although a “From” header specification sometimes specifies the value should be an email format, that is explicitly not required in this use case.

Management Actions. In some scenarios, some management actions happen for all games and for all streaming partners who follow the “host a game in a VM” model for streaming. However, some embodiments also perform different management actions being taken based on which provider is identified. For example, some scenarios support streaming of game trials on one provider but not on another provider, which the embodiment uses management actions to selectively enable or disable. Also, some scenarios perform game-specific behavior across all providers, and the embodiment identifies official and supported streaming partners. In some scenarios, individual games use this identifier mechanism 204 on a per provider basis to change game logic. Some embodiments change anti-cheat logic to recognize game streaming VMs and not immediately ban players who stream from a verified partner. Some disable specified in-game elements where the streaming provider's platform for security or space reasons cannot accommodate them, such as content to be installed separately from the game, like game modifications. Some embodiments distinguish non-cloud play from cloud play. Some embodiments change the in-game purchase experience for a set of games, based on the game streaming provider, to use a different payment platform. In some embodiments, management 408 functionality 204 changes how Quality of Service (QoS) is measured, to reflect changes in expected latency from streaming data centers versus players' homes.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as reading and writing HTTP headers 308, validating 716 requests using a security token 124, and running virtual machines 404, which are each an activity deeply rooted in computing technology. Some of the technical mechanisms discussed include, e.g., virtual machines 404, proxies 318, identity providers 412, AIGS software 302, and device directories 514. Some of the technical effects discussed include, e.g., treating 610 devices 101 differently based on whether they are virtual or physical, supporting telemetry 418 without modifying kernel 120 or game 208 code, and detecting unauthorized gameplay. Thus, purely mental processes and activities limited to pen-and-paper are clearly excluded from the scope of any embodiment. Other advantages based on the technical characteristics of the teachings will also be apparent to one of skill from the description provided.

One of skill understands that streaming 206 in a computing network 108 or other computing system 102 is technical activity which cannot be performed mentally at all, and cannot be performed manually with the speed and accuracy required in computing systems. Hence, technical improvements in game streaming 206 such as the various examples of AIGS functionality 204 described herein are improvements to computing technology. One of skill understands that attempting to manually validate 716 requests, or manually perform 610 management operations, would create unacceptable delays in software and network operations, and introduce unnecessary and unacceptable human errors. People manifestly lack the speed, accuracy, memory capacity, and specific processing capabilities required to perform verified game streaming 700 as taught herein.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as a proxy 318validat or a server 406, or in practical applications such as management operation support for storefronts and other game repositories on a game streaming platform. Embodiments provide technical mechanisms and processed which efficiently make games cloud-aware in practice without modifying the games themselves.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to prevent streaming devices such as virtual machines from exhausting a device-limited license, how to reduce or prevent unauthorized gameplay of streamed games, how to port a game which is designed to run on a standalone workstation from that standalone environment into an online streaming environment when the game's source code is unavailable, and how to port a game which runs each time on the same machine to an online streaming environment in which the game often runs on different machines from one execution to the next. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CLI: command line interface, command line interpreter
CPU: central processing unit
DLL: dynamic link library
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
IDE: integrated development environment
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or a user session or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Game streaming operations such as making calls 312, responding 320 to calls 312, running a virtual machine 404, performing 610 management actions, and many other operations discussed herein (whether recited expressly in the Figures or not), are understood to be inherently digital and computational. A human mind cannot interface directly with a CPU or other processor, or with RAM or other digital storage, to read and write the necessary data to perform the game streaming steps 700 taught herein even in a hypothetical situation or a prototype situation, much less in an embodiment's real world large computing environment, e.g., an internet-connected environment. This would all be well understood by persons of skill in the art in view of the present disclosure. Moreover, one of skill understands that game streaming functionality 204 cannot be implemented merely with conventional tools and steps, because actual implementation requires the use of teachings which were first provided in the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as altering, bypassing, calling, changing, communicating, creating, determining, differentiating, discerning, extracting, injecting, logging in, modifying, obtaining, passing, performing, placing, receiving, registering, responding, running, streaming, validating (and alters, altered, bypasses, bypassed, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; hardware tools; computational
126 display screens, also referred to as “displays”
128 computing hardware not otherwise associated with a reference numeral 106, 108, 110, 112, 114
134 cloud, also referred to as cloud environment or cloud computing environment
202 enhanced computing system, i.e., system 102 enhanced with functionality 204 as taught herein
204 AIGS functionality (also referred to as verified game streaming functionality 204, game streaming functionality 204, or functionality 204), e.g., software or specialized hardware which performs or is configured to perform steps 604 and 610, or steps 604 and 606, or steps 306 and 130, or any software or hardware which performs or is configured to perform a game streaming activity first disclosed herein, or to perform a novel method 700 first disclosed herein
600 flowchart; 600 also refers to game streaming methods that are illustrated by or consistent with the FIG. 6 flowchart or any variation of the FIG. 6 flowchart described herein; all game streaming method steps are computational, not human activity
700 flowchart; 700 also refers to game streaming methods that are illustrated by or consistent with the FIG. 7 flowchart, which incorporates the FIG. 6 flowchart, the steps in FIGS. 2, 3, and 4, and all other steps taught herein, or methods that are illustrated by or consistent with any variation of the FIG. 7 flowchart described herein; all game streaming method steps are computational, not human activity
734 any step or item discussed in the present disclosure that has not been assigned some other reference numeral; 734 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

At a proxy 318 outside a virtual machine 404 which is hosting a game 208 in a cloud 134, some embodiments select 314 a network 108 communication 130 which represents a call 312 from the game or the virtual machine. The proxy modifies 306 a header 308 of the call, or adds 720 a new header 308, with a security token 124 which is distinct from any user authentication token 322 of a game player 104. A call receiver 406 extracts 604 the token and uses it in an attempt to discern 608 an identity 414, such as a streaming provider 212 identity. The call receiver performs 610 a management action 500, and responds 320 to the call, based on one or more of: the streaming provider identity 414, 502 or another result 612 of the attempt, the particular call 312, or the presence of the security token 124. The management action manages 408 a game streaming support item such as a licensing mechanism 514, 516, 520, 530, an analytics 504 mechanism 530, a game configuration 506, or a telemetry service 418.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A game streaming method performed in a computing network, the method comprising automatically:
receiving a request via a network communication, the request part of a call to a service, the call associated with a virtual device;
extracting a security token from the request;
attempting to discern a verified game streaming provider identity based on at least the security token; and
based on at least a result of the attempting, performing at least one of:
(a) an identity operation with an identity of the virtual device;
(b) an analytics operation with the virtual device or a game installed on the virtual device, or both;
(c) a game configuration operation with the game; or
(d) a refusal operation after the attempting fails to discern the game streaming provider identity or ascertains that the game streaming provider identity identifies an unauthorized entity.

2. The method of claim 1, comprising performing the identity operation, and wherein the identity operation comprises at least one of:
registering an identity of a pseudo-device in a device directory in place of the identity of the virtual device;
registering an identity of a device group in a device directory in place of the identity of the virtual device, the device group containing multiple virtual devices;
bypassing registration of the virtual device in a device directory;
bypassing entry of the virtual device into a list of devices owned by a user; or
bypassing incrementation of a user's device count in response to use of the virtual device by the user.

3. The method of claim 1, comprising performing the analytics operation, and wherein the analytics operation comprises at least one of:
differentiating analytics for how the game is running in a game streaming session; or
altering a quality-of-service threshold to correspond with a streaming latency instead of a home play latency.

4. The method of claim 1, comprising performing the game configuration operation, and wherein the game configuration operation comprises at least one of:
determining a game setting which is tailored for use when a game is running in a game streaming environment;
determining a game matchmaking service setting; or
determining a game trial configuration or a status of a game trial mechanism.

5. The method of claim 1, further comprising selecting the call for bearer token insertion, wherein the selecting is based on at least one of:
a call identity which distinguishes the call from at least one other call;
a service identity which distinguishes the service from at least one other service;
a service location;
a game identity which distinguishes the game from at least one other game; or
the game streaming provider identity, which distinguishes the game streaming provider from at least one other game streaming provider.

6. The method of claim 5, wherein the selecting is performed in a proxy which is outside the virtual device.

7. The method of claim 1, further comprising sending a response to the request via the computing network, wherein the response comprises at least one of:
the result of the attempting; or
an indication of at least one operation which was performed based on at least the result of the attempting.

8. The method of claim 1, further comprising at least one of:
changing an in-game purchase configuration or an in-game purchase user interface based on at least the game streaming provider identity;
changing an anti-cheat configuration or a status of an anti-cheat mechanism based on at least a response to the request; or
changing an in-game configuration or a status of an in-game feature based on at least a response to the request.

9. A game streaming method performed in a computing network, the method comprising automatically:
receiving a hypertext transfer protocol (HTTP) request via a network communication, the HTTP request part of a call to a service, the call associated with a virtual device, the call also associated with a game installed on the virtual device;
extracting a bearer token from a header of the HTTP request;
attempting to discern a verified game streaming provider identity based on at least the bearer token; and
based on at least a result of the attempting, performing at least one of:
(a) an identity operation with an identity of the virtual device; or
(b) a game configuration operation with the game.

10. The method of claim 9, wherein the HTTP request is a secure HTTP request, namely, an HTTPS request.

11. The method of claim 9, comprising performing the identity operation, and wherein the identity operation comprises at least one of:
registering an identity of a pseudo-device in a device directory in place of the identity of the virtual device;
registering an identity of a device group in a device directory in place of the identity of the virtual device, the device group containing multiple virtual devices;
bypassing registration of the virtual device in a device directory;
bypassing entry of the virtual device into a list of devices owned by a user; or
bypassing incrementation of a user's device count in response to use of the virtual device by the user.

12. The method of claim 9, comprising performing the game configuration operation, and wherein the game configuration operation comprises at least one of:
determining a game setting which is tailored for use when a game is running in a game streaming environment;
determining a game matchmaking service setting; or
determining a game trial configuration or a status of a game trial mechanism.

13. The method of claim 9, further comprising validating at least a portion of the HTTP request based on at least the bearer token.

14. The method of claim 9, further comprising sending a response to the HTTP request via the computing network after the attempting succeeds in discerning the verified game streaming provider identity.

15. The method of claim 9, wherein the bearer token itself, the extracting, and the attempting are all transparent to the game which is installed on the virtual device.

16. A game streaming method performed in a computing network, the method comprising automatically:
receiving a hypertext transfer protocol (HTTP) request via a network communication, the HTTP request part of a call to a service, the call associated with a virtual machine, the call also associated with a game installed on the virtual machine;
extracting a bearer token from a header of the HTTP request, the extracting not visible to the game;
attempting to discern a verified game streaming provider identity based on at least the bearer token, the attempting not visible to the game; and
sending a response to the HTTP request via the computing network after the attempting, wherein the response indicates a result of the attempting.

17. The method of claim 16, further comprising injecting the bearer token into the header of the HTTP request prior to the receiving, and wherein the bearer token is distinct from a user authentication token of the HTTP request.

18. The method of claim 16, further comprising placing a game streaming provider name into the HTTP request prior to the receiving, the game streaming provider name comprising a string which represents a name of the game streaming provider.

19. The method of claim 16, further comprising selecting the HTTP request for bearer token insertion, wherein the selecting is based on at least one of:
a call identity which distinguishes the call from at least one other call;
a service identity which distinguishes the service from at least one other service;
a service location;
a game identity which distinguishes the game from at least one other game; or
the game streaming provider identity, which distinguishes the game streaming provider from at least one other the game streaming provider.

20. The method of claim 16, further comprising passing the virtual machine a transfer token after a user login, wherein the transfer token permits the game to be launched and streamed without an additional login.
